(19) United States
(12) Patent Application Publication
(10) Pub. No.: US 2014/0325526 A1
(43) Pub. Date: Oct. 30, 2014

(54) INFORMATION PROCESSING SYSTEM, INFORMATION PROCESSING METHOD, AND RECORDING MEDIUM STORING INFORMATION PROCESSING PROGRAM

(71) Applicants: Tadashi NAGATA, Kanagawa (JP); Tomoki SHIBUKAWA, Kanagawa (JP); Hajime KUBOTA, Kanagawa (JP)

(72) Inventors: Tadashi NAGATA, Kanagawa (JP); Tomoki SHIBUKAWA, Kanagawa (JP); Hajime KUBOTA, Kanagawa (JP)

(73) Assignee: RICOH COMPANY, LTD., Tokyo (JP)

(21) Appl. No.: 14/247,385

(22) Filed: Apr. 8, 2014

(30) Foreign Application Priority Data
Apr. 25, 2013 (JP) 2013-091952

(51) Int. Cl. G06F 9/54

(52) U.S. Cl. CPC G06F 9/544; G06F 2209/545; G06F 2209/547
USPC 719/312

(57) ABSTRACT

An information processing system includes an operation acceptance unit that accepts operations, a discrimination unit that distinguishes between an operation to be recorded and an operation not to be recorded among the operations accepted by the operation acceptance unit, and a recording unit that records the operations that the discrimination unit identifies as an operation to be recorded among the operations accepted by the operation acceptance unit in a memory.

### CROSS-REFERENCE TO RELATED APPLICATION

This patent application is based on and claims priority pursuant to 35 U.S.C. §119(a) to Japanese Patent Application No. 2013-091952, filed on Apr. 25, 2013 in the Japan Patent Office, the entire disclosure of which is hereby incorporated by reference herein.

### BACKGROUND

1. Technical Field

The present invention relates to an information processing system, an information processing method, and a recording medium storing an information processing program.

2. Background Art

Conventionally, in information processing systems, recording a series of operations performed by a user for later reproduction is often done. Here. “to reproduce” means that, by invoking the recorded operation, the information processing system operates as if the same operations are performed on site.

By utilizing the functions of recording and reproducing even complicated operations, it is possible to reduce burden of operation, in case the operations are recorded once, by just invoking the recorded operations next time. For example, there are techniques that, in managing workflow, sub-flow is executed arbitrarily in a working process during the workflow and the working process in which the sub-flow was executed is considered to be finished in case all operations by the sub-flow finishes.

### SUMMARY

Example embodiments of the present invention provides an information processing system that includes an operation acceptance unit that accepts operations, a discrimination unit that distinguishes between an operation to be recorded and an operation not to be recorded among the operations accepted by the operation acceptance unit, and a recording unit that records the operations that the discrimination unit identifies as an operation to be recorded among the operations accepted by the operation acceptance unit in a memory.

Further example embodiments of the present invention provide an image processing method, and a non-transitory recording medium storing an image processing program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a block diagram illustrating a hardware configuration of an image processing system as an embodiment of the present invention.

FIG. 2 is a diagram illustrating software configurations of a main unit and a control unit shown in FIG. 1 along with functions for network communication.

FIG. 3 is a diagram illustrating functional configurations regarding recording operations accepted from a user and reproducing the operations included in the image processing system shown in FIG. 1.

FIG. 4 is a diagram illustrating criteria for determining recording necessity by a recording necessity determination unit shown in FIG. 3.

FIG. 5 is a diagram illustrating an example of an operation recording format.

FIG. 6 is a flowchart illustrating a process that a CPU in the control unit shown in FIG. 1 executes to record the operations.

FIG. 7 is a flowchart illustrating a process that the CPU in the control unit shown in FIG. 1 executes to reproduce the operations.

FIGS. 8A and 8B are diagrams illustrating timing of the operations reproduced by the process shown in FIG. 7.

FIGS. 9A and 9B are diagrams illustrating other criteria for determining recording necessity by the recording necessity determination unit.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the conventional information processing systems, recording a series of operations is indiscriminate, including operations that are unnecessary for reproduction, and as a consequence in some cases interfering with the use of recorded data.

In the following embodiment, an information processing system is provided that facilitates recording operations suitable for reproducing.

First, a configuration of an image processing system as an embodiment of an information processing system in the present invention is described below.

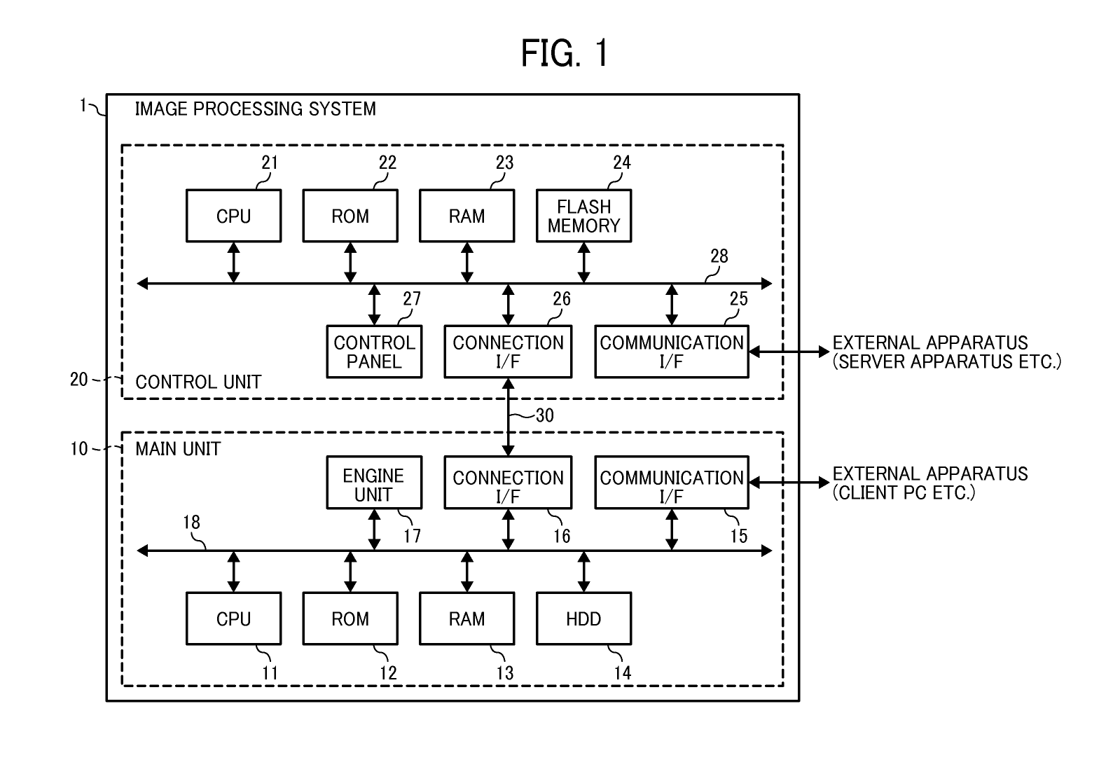

FIG. 1 is a block diagram illustrating a hardware configuration of an image processing system 1.

The image processing system 1 is a multifunctional peripheral (MEP) that includes communication functions as well as functions such as printing, scanning, and facsimile. A user can operate the image processing system 1 directly and instruct the image processing system to process these functions. Otherwise, the image processing system 1 is connected to an external apparatus such as a client personal computer (PC) communicably, and the image processing system 1 can execute the functions in response to a command received from the external apparatus.

As shown in FIG. 1, the image processing system 1 includes a control unit 20 that accepts inputting a command by a user and a main unit 10 as an operating unit that works based on the command accepted by the control unit 20. In the image processing system 1, the control unit 20 and the main unit 10 can communicate with each other via a communications channel 30 for example. In this embodiment, the communications channel 30 consists of a control wire and a power wire. Otherwise, the control wire can be separated from the power wire.

The main unit 10 can perform an operation in response to not only a command accepted by the control unit 20 but also a command received from the external apparatus as described above. In the present embodiment, the communications channel 30 is compliant with Universal Serial Bus (USB) specification, for example, although the communications channel 30 can be compliant with any wired or wireless specification. In addition, the communications channel 30 can be not only one-to-one but also a network. Other than USB, e.g., serial, wired local area network (LAN), wireless LAN, Bluetooth, and Infrared Data Association (IrDA) can be used for the communications channel 30.

The main unit 10 includes a CPU 11, a ROM 12, a RAM 13, a hard disk drive (HDD) 14, a communications interface (I/F) 15, a connection I/F 16, and an engine unit 17, all connected to a system bus 18. The main unit 10 as a whole is controlled by the CPU 11 executing a program stored in the ROM 12 or the HDD 14 using the RAM 13 as a work area. In addition, various functions such as copying, scanning, printing, and facsimile described above are implemented by the CPU 11 executing a program stored in the ROM 12 or the HDD 14 using the RAM 13 as a work area.

The HDD 14 is a nonvolatile storage medium (storage unit) and stores various data including various programs executed by the CPU 11.

The communications 1/F 15 is an interface to communicate with an external apparatus via the network 3.

The connection I/F 16 is an interface to communicate with the control unit 20 via the communications channel 30. In this embodiment, an interface compliant with USB specification is used for the connection I/F 16. However, any specification whether wired or wireless can be adopted as the communications 1/F 15 and the connection I/F 16. One I/F can double as the communications I/F 15 and the connection I/F 16. Conversely, the main unit 10 can include three or more I/Fs used for communicating.

The engine unit 17 is hardware that executes processes to implement the printing function, scanning function, copying function, and facsimile function except general-purpose information processing and communication. For example, the engine unit 17 includes a scanner (an image scanning unit) that scans a document to create and image thereof, a plotter (an image forming unit) that performs printing on sheet material such as paper, and a communication unit that performs facsimile communication, etc. Furthermore, the engine unit 17 can include specific options such as a finisher that sorts printed sheet material and an Auto Document Feeder (ADF) that feeds documents automatically.

The control unit 20 includes a CPU 21, a ROM 22, a RAM 23, a flash memory 24, a communications I/F 25, a connection I/F 26, and a control panel 27, all connected to a system bus 28. The whole of the control unit 20 is controlled by the CPU 21 by executing a program stored in the ROM 22 or the flash memory 24 using the RAM 23 as a work area. In addition, various functions such as recording and reproducing user operations are implemented by the CPU 21 by executing a program stored in the ROM 22 or the flash memory 24 using the RAM 23 as a work area.

The flash memory 24 is a nonvolatile storage medium (storage unit) and stores various programs executed by the CPU 21 and various data including configuration information referred to in recording operations.

The communications I/F 25 is an interface to communicate with an external apparatus such as a server apparatus via a network.

The connection I/F 26 is an interface to communicate with the main unit 10 via the communications channel 30. In this embodiment, an interface compliant with USB specification is used for the connection I/F 26. However, any specification, whether wired or wireless, can be adopted as the communications I/F 25 and the connection I/F 26. One I/F can double as the communications I/F 25 and the connection I/F 26. Conversely, the control unit 20 can include more than three I/Fs used for communicating.

The control panel 27 is an operational display unit that includes a control unit that accepts commands to execute various operations and an operation to configure, etc., and a display part that displays operational status and configuration of the image processing system 1. For example, the control panel 27 can be comprised of a liquid crystal display (LCD) panel on which a touch panel is laminated. Furthermore, in addition to or instead of an LCD panel, a control unit such as hardware keys and a display part such as a lamp can be set up.

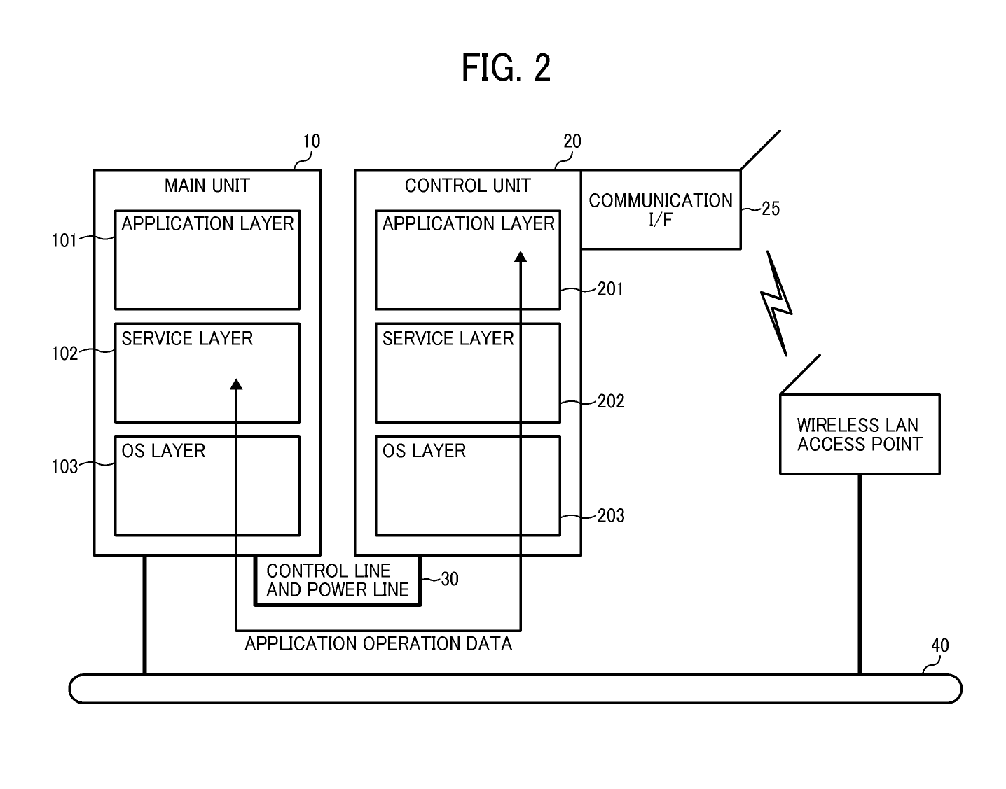

FIG. 2 is a diagram illustrating software configurations of the main unit 10 and the control unit 20 shown in FIG. 1 along with functions regarding network communication between the control unit 20 and the network.

As shown in FIG. 2, the main unit 10 includes groups of software that consist of an application layer 101, a service layer 102, and an operating system (OS) layer 103.

Software in the application layer 101 provides predetermined functions by operating the hardware resources. For example, a copier application, a scanner application, a printer application, and a fax application are included in the application layer, and they provide various functions such as copy capability, scan capability, print capability, and fax capability.

Software in the service layer 102 intervenes between the application layer 101 and the OS layer 103, and provides an interface for using the hardware resources included in the main unit 10 to the software in the application layer 101. In particular, the software in the service layer 102 implements functions such as accepting request to operate the hardware resources and arbitrating those requests to operate. Examples of the request to operate accepted by the service layer 102 are scanning by the scanner and printing by the plotter for example.

This interface function is provided not only to the application layer 101 in the main unit 10 but also to the application layer 201 in the control unit 20. That is, an application included in the application layer 201 in the control unit 20 can implement various functions using the hardware resources in the main unit 10 (e.g., the engine unit 17) by accessing the service layer 102 too.

The OS layer 103 includes the operating system and provides basic functions that control the hardware included in the main unit 10. The software in the service layer 102 converts the requests to use the hardware resources sent from the various applications into commands that the OS layer 103 can interpret and pass the commands to the OS layer 103. Subsequently, the software in the OS layer 103 executes the commands and instructs the hardware resources to operate in accordance with the requests from the applications.

The application layer 201, the service layer 202, and the OS layer 203 in the control unit 20 have the similar hierarchical structure as the main unit 10 too. Particular functions provided by the applications in the application layer 201 and types of requests to operate that the service layer 202 can accept are different from the case with the main unit 10. While the applications included in the main unit 20 can provide predetermined functions by operating the hardware resources included in the control unit 20, the applications included in the main unit 20 mainly provide user interface (UI) functions for operating and displaying the functions that the main unit 10 includes.

In the image processing system 1 in this embodiment, each of the main unit 10 and the control unit 20 can be equipped with an OS individually, and the main unit 10 and the control unit 20 can work independently. In addition, if the main unit 10 and the control unit 20 can communicate with each other, it is not always necessary that the OS of the main unit 10 is the same as the OS of the control unit 20. For example, while the main unit 10 can use Linux as its OS, the control unit 20 can use Android as its OS. However, it is not required that the OS of the main unit 10 operates independently from the OS of the control unit 20.

In the image processing system 1 described above, since the main unit 10 is controlled by the OS different from the OS that controls the control unit 20, communication between the main unit 10 and the control unit 20 is performed not as interprocess communication within an apparatus but communication between different apparatuses.

Examples of the communication between the main unit 10 and the control unit 20 include notifying the main unit 10 of a content of a user's command accepted by the control unit 20 (command communication), and notifying the control unit 20 of information to be displayed on the control unit 20 from the main unit 10.

Consequently, the control unit 20 can utilize the functions included in the main unit 10 by performing command communication from the control unit 20 to the main unit 10. The events that the main unit 10 reports to the control unit 20 include execution statue of operations in the main unit 10 and content of settings configured in the main unit 10 etc.

Since the power of the control unit 20 is supplied from the main unit 10 via the communications channel 30, the control unit 20 can operate independently from the power control of the main unit 10. The main unit 10 operates on the OS separated from the OS of the control unit 20, and the applications in the control 20 can operate utilizing the functions included in the main unit 10 in order to assure of independence of functionality.

One key point in the image processing system described above is a function that records and reproduces user function. The key point is described below.

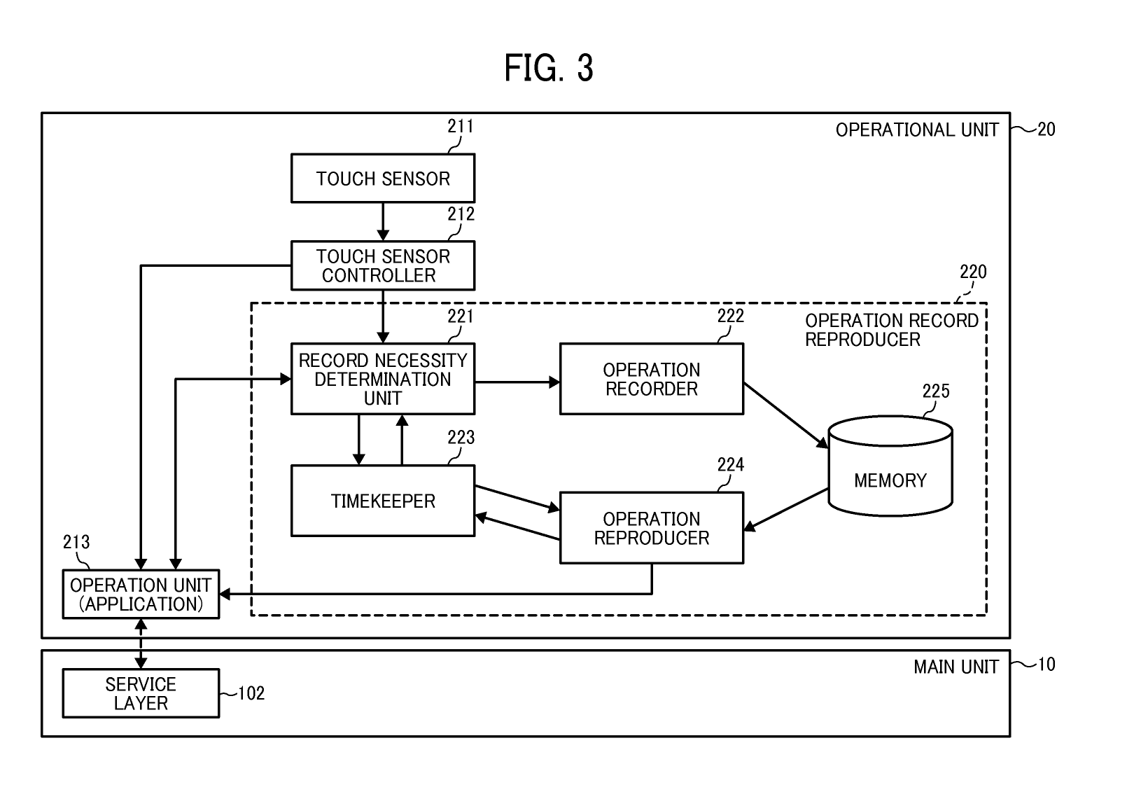

FIG. 3 is a diagram illustrating functional configurations included in the image processing system shown in FIG. 1 regarding recording user operations and reproducing the operations.

As shown in FIG. 3, in the image processing system 1, the control unit 20 includes the functions of recording and reproducing user operations.

A touch sensor 211 is included in the control panel 27 and detects the user operations. In addition, the touch sensor 211 can detect simultaneous operation on two points on a detection plane. Other than that, operating devices such as keys and buttons can be laid out and used for detecting the user operations.

The service layer in the control unit 20 provides a function of a touch sensor controller 212, and the touch sensor controller 212 controls the touch sensor 211 and determines a position and type of user operation detected by the touch sensor 211. In this embodiment, types of user operations that the touch sensor 211 can determine are touch, holding down, drag, flick, pinch in, pinch out, double tap, and rotating two fingers. Of course, other operation types can be detected.

Based on the determination result described above, the touch sensor controller 212 passes operation information that indicates the position and type of detected operation to an (active) application 213 corresponding to the screen currently displayed.

The touch sensor 211 and the touch sensor controller 212 described above functions as an operation acceptance unit.

The application 213 is a function implemented by the program in the application layer 201 and currently displays a screen on the control panel 27 (accepts user operations on the control panel 27) in the control unit 20.

After receiving the operation information from the touch sensor controller 212, based on the position and type of user operation indicated by the operation information, the application 213 determines on which area or object in the screen currently displayed on the control panel 27 the user operation was performed.

Here, the objects are arbitrary display components displayed on the screen such as an icon, button, switch, pull-down menu, scroll bar, character, and image. The object and its position to be operated is defined by data of the screen.

The operation target can be not a specific object but the screen itself or a specific area in the screen. In this case, position of the area (or whole screen is one area) is defined by data of the screen.

The application 213 performs operation in accordance with the specified operation target and operation type. For example, if the flick operation is performed on a preview image of a document in a preview screen of the document, the application 213 flips a page of the document and switches into next page. If the touch operation is performed on the icon to instruct to change settings, the application 213 changes the settings corresponding to the icon. If the touch operation is performed on the icon to instruct to start executing a job, the application 213 starts executing the job etc.

In some cases, the application 213 needs to perform operations that utilizes the main unit 10 (e.g., copying operation) in accordance with the detected user operation. In this case, the application 213 generates a command that instructs the main unit 10 to perform the operation and sends the command to the service layer 102 in the main unit 10.

An operation record reproducer 220 includes a capability to record and reproduce the user operations. The capability of the operations record reproducer 220 is also implemented by the program in the application layer 201. The capability can be a part of capabilities provided by the application 213 or implemented by another program.

The operation record reproducer 220 can operate in three modes, recording mode, reproducing mode, and standby mode. The operation record reproducer 220 is in the standby mode when it launches. The operation record reproducer 220 transitions to the recording mode in case of being instructed to start recording user operations and to the standby mode in case of either being instructed to stop recording or reproducing or finishing reproducing a series of operations.

While the operation record reproducer 220 is working, the touch sensor controller 212 passes the operation information described above not only to the application 213 but also to a recording necessity determination unit 221 in the operation record reproducer 220.

Except in the recording mode, just like the case of the application 213, in order to perform operation in accordance with the operations indicated by the operation information received from the touch sensor controller 212, the recording necessity determination unit 221 passes the operation information to a functional unit (not shown in figures) supposed to perform the operation.

By contrast, in the recording mode, the recording necessity determination unit 221 acquires information on the screen currently displayed on the control panel 27 from the application 213 etc. Subsequently, the recording necessity determination unit 221 determines on which area or object in the screen currently displayed on the control panel the operation was performed. (Instead of using the operation information, the recording necessity determination unit 221 can acquire the information on the operation object and the operation type from the application 213.)

Subsequently, the recording necessity determination unit 221 functions as a discrimination unit and identifies whether or not the operations indicated by the received operation information is to be recorded based on predetermined criteria. These criteria can be specified based on information such as operation type, operation target, and type of screen displayed when the operation was performed etc. In addition, a supplier of the application that implements the capability of the recording necessity determination unit 220 can define the criteria, or the criteria can be configured arbitrarily.

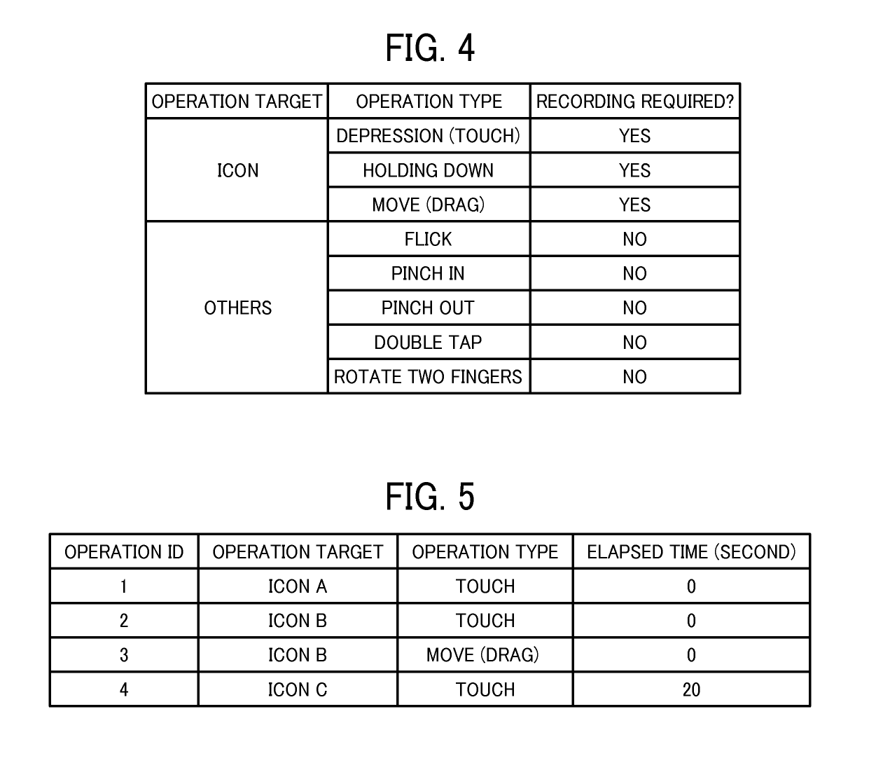

FIG. 4 is a diagram illustrating criteria for determining recording necessity by the recording necessity determination unit 221.

The criteria shown in FIG. 4 indicate that operations on icons are recorded and other operations are not recorded. That is, the recording necessity is identified by the target of the operation.

Here, the operations on icons are considered as operations to change status of application substantively such as changing settings and starting executing a job etc., and the other operations are considered as operations just to enlarge, reduce, and scroll the referred screen etc. In this case, operations that just change appearance of the screen are not recorded since it is unnecessary to reproduce those operations, and only operations that change the status of the application substantively can be recorded to reproduce them later.

Similar criteria can be defined as a distinction among operation types, for example, operations such as depression (touch), holding down, and move (drag) are recorded, and operations such as flick, pinch in, pinch out, double tap, and rotate two fingers are not recorded, since first three operations are performed on icons and others are performed on targets other than icons.

Getting back to the description shown in FIG. 3, the necessity of record determination unit 221 passes information that indicates content of operation determined as operation to be recorded based on the criteria described above to an operation recorder 222. The information can be passed in a format suitable for recording by the operation recorder 222. The information can indicate the target and type of user operation, or the information can indicate the coordinate and type of user operation. After acquiring information on elapsed time of a timer from a timekeeper 223, the recording necessity determination unit 221 passes it to the operation recorder 222 along with the operation information.

The operation recorder 222 is a recording unit and similarly stores the operation information passed from the recording necessity determination unit 221 in a memory 225 associated with the information on the time elapsed from the recording necessity determination unit 221. The memory 225 can be included in the RAM 23 or the flash memory 24. As shown in FIG. 5, an example of a recording format in the memory 225 can associate the target and type of user operation with the elapsed time, and it can be stored sequentially along with an operation ID in the recording order. Otherwise, it is possible to record information associated the coordinate and type of user operation with the elapsed time.

The recording necessity determination unit 221 does not start the time in the timekeeper 223 at the beginning of the recording mode. The recording necessity determination unit 221 starts the timekeeper keeping time at the time of detecting a job execution start operation firstly after starting the recording mode. Consequently, all operations until the first job execution start operation are recorded with zero elapsed time, and subsequent operations are recorded with the elapsed time from the first job execution start operation.

The job execution start operation differs depending on the working application 213. The recording necessity determination unit 221 preliminarily stores information on which operation is the job execution start operation. The application 213 can provide this information to the operation record reproducer 220, or the operation record reproducer 220 can acquire this information with reference to the configuration information of the application 213 or the configuration information of the screen currently displayed.

The timekeeper 223 times using the timer and functions as a measuring unit. The timekeeper 223 resets the elapsed time at the beginning of the recording mode and the reproducing mode. In the recording mode, the timekeeper 223 starts timing in response to the instruction from the recording necessity determination unit 221. In the reproducing mode, the timekeeper 223 starts timing at the time of starting the reproducing mode (or after finishing reproducing all operations whose elapsed time are 0).

The operation reproducer 224 reproduces the user operations based on the operation information that the operation recorder 222 stores in the memory 225 and functions as a reproducing unit. More specifically, after starting the reproducing mode, at the timing when the elapsed time for each operation stored in the memory 225 goes on, the operation reproducer 224 passes information that indicates that the operation was performed to the application 213 which is active at that time. After receiving the operation information from the operation reproducer 224, the application 213 operates as if the application 213 determines that the operations was performed based on the operation information received from the touch sensor controller 212. Conversely, the operation reproducer 224 passes the operation information to the application 213 in the format of instructing the application 213 to perform the operation. It is preferable to store the information on the operations in the memory 225 in the format suitable for that purpose.

By using the functions of each unit described above, it is possible to record the operations performed on the active application 213 after launching the operation record reproducer 220 and transitions it to the recording mode by using the control unit 20. In this case, since it is possible to record the operations excluding the operations with low necessity to reproduce later without particular operation, it is possible to record the operations suitable for reproducing preferably.

Next, a process to record the operations executed by the CPU 21 in the control unit 20 is described below.

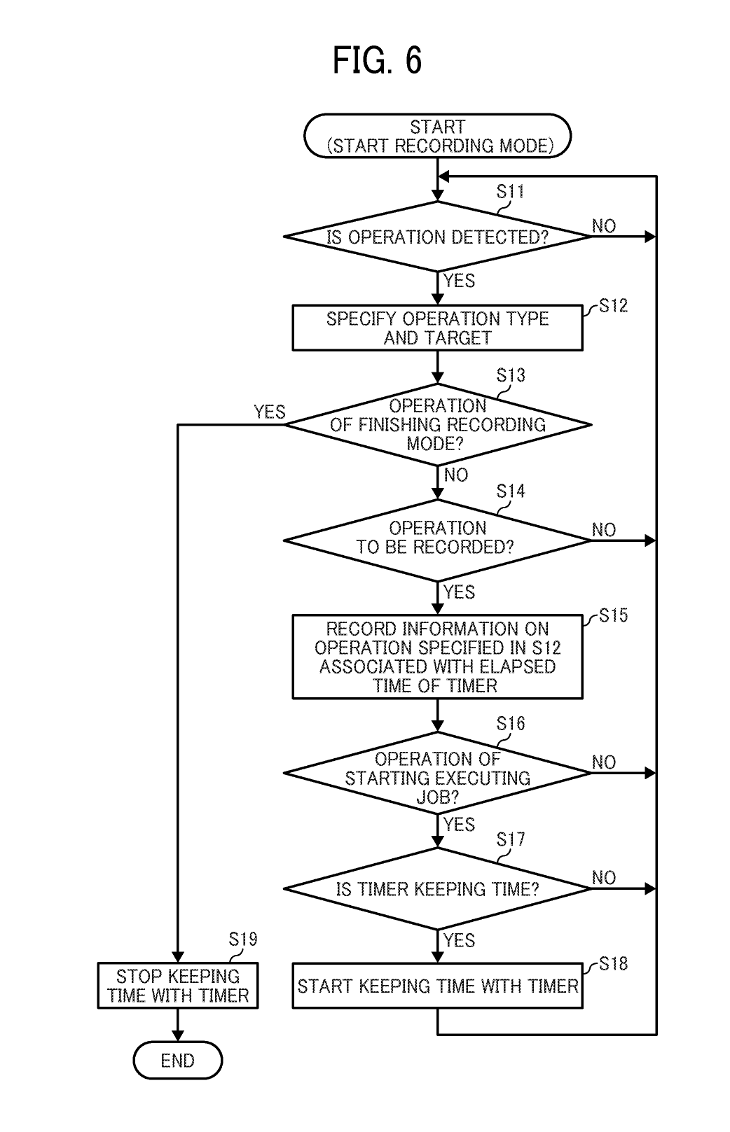

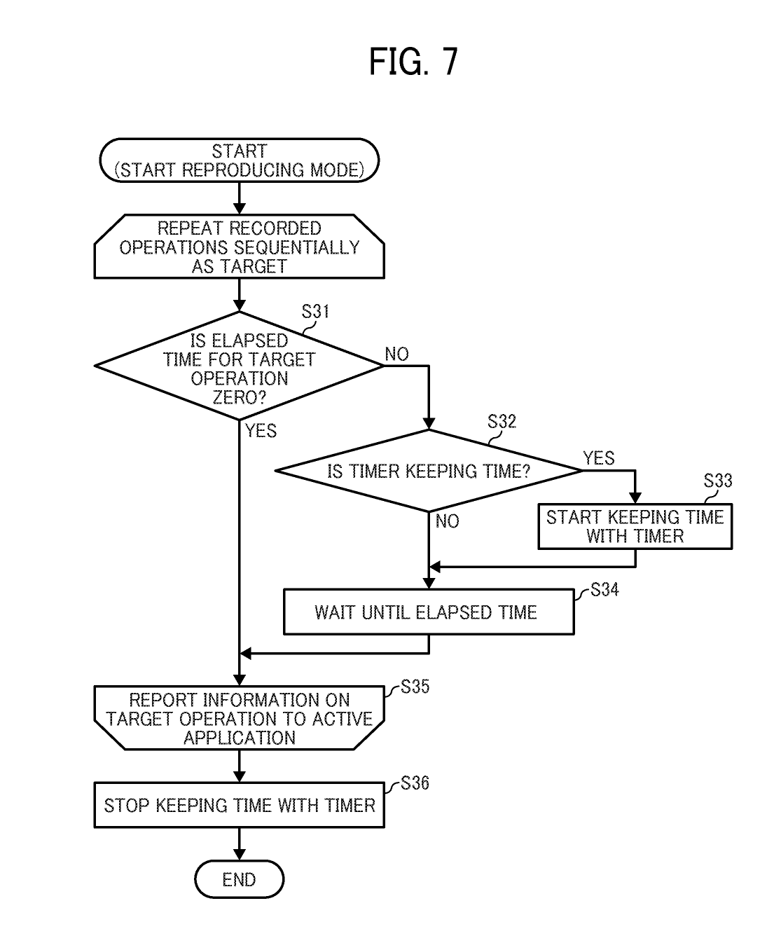

FIG. 6 is a flowchart illustrating the process that the CPU 21 in the control unit 20 executes.

After detecting the instruction to transition the operation record reproducer 220 to the recording mode, the CPU 21 in the control panel 20 starts the process shown in the flowchart in FIG. 6 as the process corresponding to the function of the operation record reproducer 220.

In this process, first, the CPU 21 stands by until it detects user operation, that is, the recording necessity determination unit 221 acquires the operation information from the touch sensor controller 212 in S11. This step corresponds to reception of the operation.

After detecting the operation, the CPU 21 specifies the type and target of the operation based on the acquired operation information regarding the operation and the information on the screen displayed on the control panel 27 currently in S12.

Next, the CPU 21 determines whether or not the operation specified in S12 is a predetermined operation of finishing the recording mode in S13. If the operation is not the operation of finishing the recording mode, the CPU 21 determines whether or not the operation specified in S12 is an operation to be recorded based on the criteria shown in FIG. 4 in S14. This step corresponds to recognition.

If it is determined that the operation is to be recorded in S14, the CPU 21 stores the operation information specified in S12 in the memory 225 associated with the elapsed time timed by the timer in S15. This step corresponds to recording. As described in detail later, since the timer is not started until a job execution start operation is detected firstly, it is possible to record zero as elapsed time during this period.

Next, the CPU 21 determines whether or not the operation specified in S12 is an operation of instructing the application 213 to start executing a job in S16. The information on which operation performed on which target becomes the job executing start operation can be acquired from the application 213.

If it is determined that the operation is the job execution start operation in S16, the CPU 21 determines whether or not the timer is timing in S17 and instructs the timer to start timing in case the timer is not timing in S18. Subsequently, in either case, the step goes back to S11 and repeats the steps. It is similar in case it is determined that the operation is not the job execution start operation in S16.

If it is determined that the operation is a recording mode finish operation, it is instructed the timer to stop timing, and the process ends, thereby completing recording the series of the operations.

As described above, the CPU 21 can store the operations determined to be recorded based on the information on the target and type of operation and the screen type currently displayed among series of operations performed between the recording mode start operation and the recording mode finish operation in the memory 225.

Here, in the steps from S16 to 518, the job execution start operation is considered as a separator among series of operations to be recorded, and the elapsed time from the separator operation to the next operation or the subsequent operations is recorded. That is, the CPU 21 functions as a separator recognition unit in these steps.

Before instructing to start executing a job on the control unit 20, it is usually considered that necessary configuration operations on various items are performed on the control unit 20, and it is considered that it is unnecessary to reproduce the operations performed during that period. Instead, it is preferable to reproduce the operations deleting the intervals between the operations and to be able to configure quickly. By contrast, after starting executing the job, since it is considered that various operations are performed in accordance with the progress of the job execution, it is highly necessary to reproduce the operations during that period in real time. Consequently, it is useful for recording the operations suitable for reproducing to regard the elapsed time as zero before the job execution start operation and to record operations including the actual elapsed time after the job execution start operation as described above.

The operation regarded as a separator is not limited to the job execution start operation. Assuming that it is predetermined, it is possible to determine whether or not a specific operation is a separator (the operation is considered as a trigger for starting timing) by using arbitrary criteria.

Next, a process to reproduce the operations executed by the CPU 21 in the control unit 20 is described below.

FIG. 7 is a flowchart illustrating the process that the CPU 21 in the control unit 20 executes. After specifying the series of operations to be recorded and detecting an instruction of starting the operation record reproducer 220 reproducing the operations, the CPU 21 in the control panel 20 starts the process shown in the flowchart in FIG. 7 as the process corresponding to the function of the operation record reproducer 220 in the reproducing mode.

In this process, the CPU 21 repeats steps from S31 to S35 considering the operations recorded as the specified series of operations as the target to be processed sequentially.

More specifically, first, the CPU 21 determines whether or not the elapsed time recorded corresponding to the operation target is zero in S31. If it is determined to be zero, the information on operations to be processed (information that indicates which type of operation is performed on which target) is passed to the active application immediately in S35, and the CPU 21 goes on to the next operation to be processed. If there is no operation to be processed, the CPU 21 stops the timer timing in S36, and the process ends.

By contrast, if it is determined that the elapsed time is not zero in S31, the CPU 21 instructs the timer to start timing if the timer is not timing in S32 and S33. Subsequently, in either case, the CPU 21 stands by until the timer times the elapsed time corresponding to the operation to be processed in S34 and provides the operation information to be processed to the application 213 afterward in S35. The following steps are similar to the case that it is determined as YES in S31.

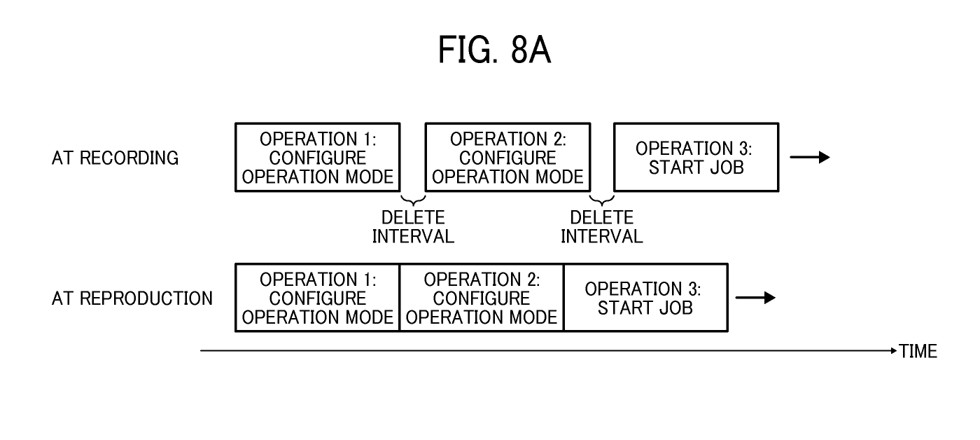

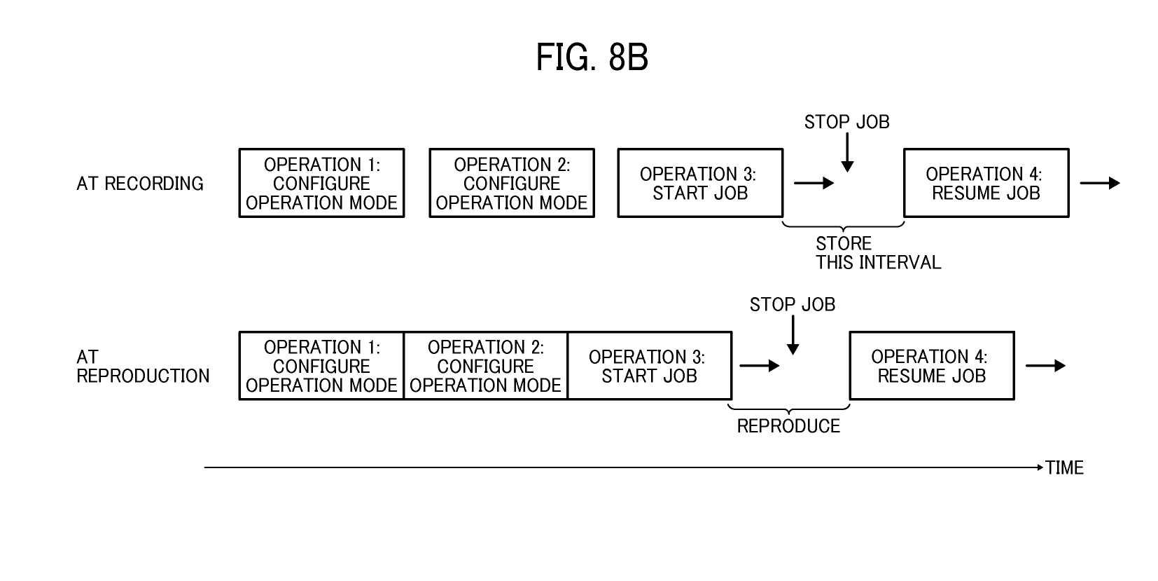

Next, the operations reproduced by the process shown in FIG. 7 are described below with reference to FIGS. 8A and 8B.

An example that does not include particular operations after starting the job is shown in FIG. 8A.

In recording the operations, while there are some intervals between the user operations from 1 to 3, these operations are recorded regarding the elapsed time as zero. Therefore, the operation intervals are deleted in reproduction the operations, and the operation information is passed to the application 213 as if all operations are performed simultaneously or at the quite adjacent timing.

Consequently, in reproducing the operations, it is unnecessary to take intervals between the operations and it is possible to acquire the operation result quickly.

An example that includes operations after starting the job is shown in FIG. 8B.

While the user operations from 1 to 3 are similar to the case in FIG. 8A, regarding the operation 4 performed after starting the job, the elapsed time from the job start operation (operation 3) is recorded in recording the operation. Regarding operations after starting the job, it is assumed that the job is interrupted after certain amount of time from the start of the job, and operation of resuming the job subsequently can be considered. In addition, operations such as an operation on executing result of jobs are considered meaningless if it is performed right after starting the job.

Consequently, in reproducing these operations, the next operation information is provided to the application 213 after elapsed time just like in recording. Therefore, just like in recording the operations, it is possible to instruct the application 213 to resume the job after the job is interrupted.

Regarding these recording and reproducing, if only the determining condition for the operation considered as the trigger to start the timer timing in the process shown in FIG. 6 is configured appropriately, in recording the operations, it is unnecessary to recognize that until which operation the operations are reproduced with deleting intervals and from which operation the operations are reproduced at intervals the same as in recording. Consequently, it is possible to record operations suitable for reproducing easily.

In the present invention, specific configurations of each component, content of the processes, data format, and conditions of various determinations etc. are not limited to the embodiment described above.

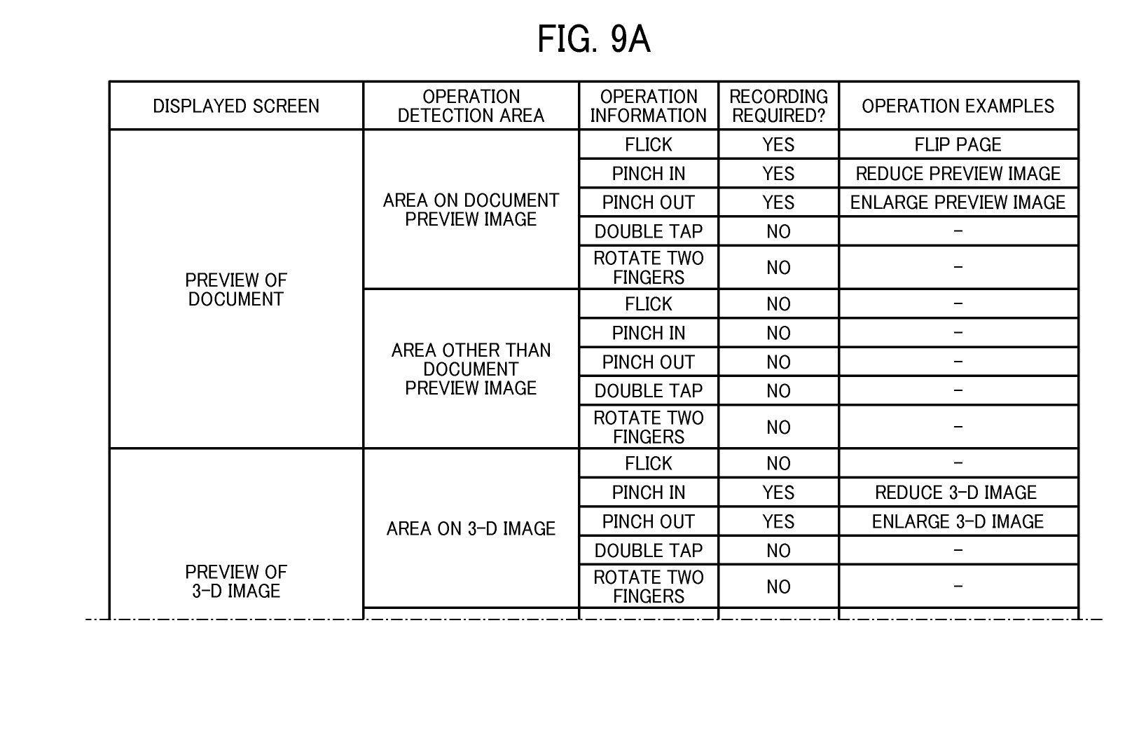

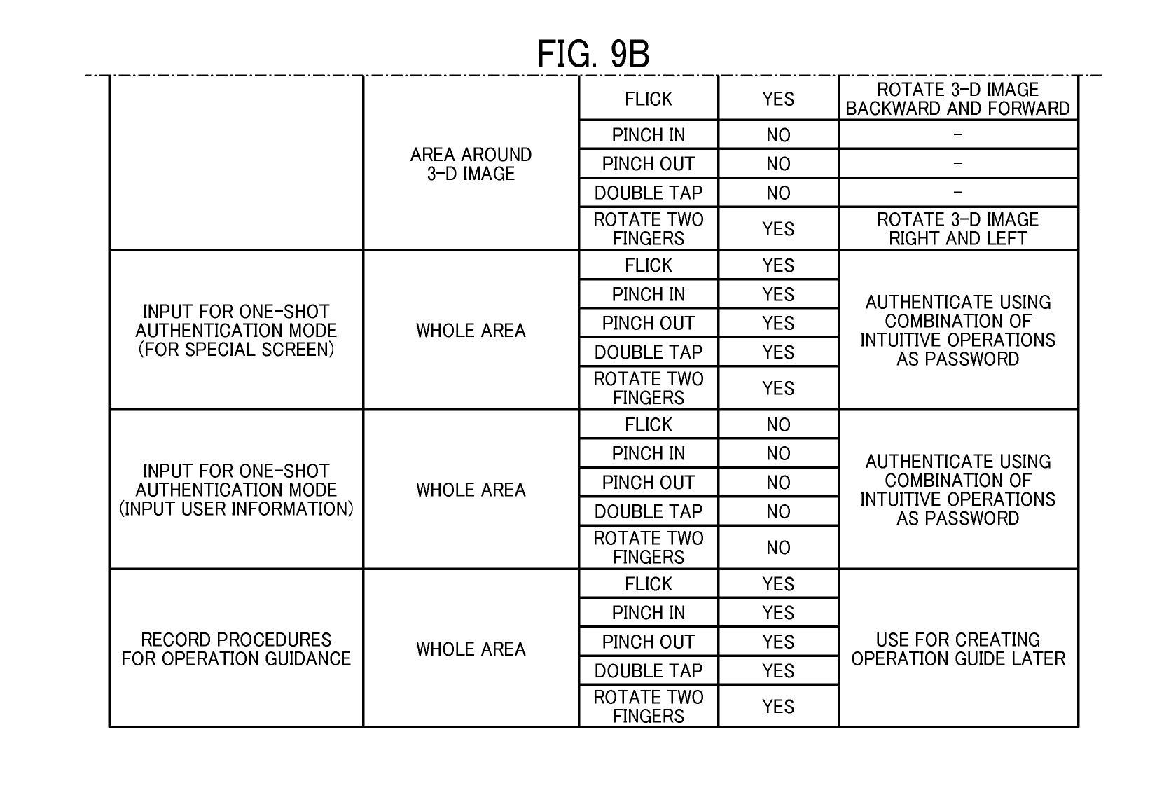

For example, the criteria for determining whether or not the operation is to be recorded in S14 shown in FIG. 6 can be exchanged with determination criteria that considers the screen type. FIGS. 9A and 9B are diagrams illustrating an example of the determination criteria described above.

In FIGS. 9A and 9B, criteria for selecting operations to be recorded considering the type of screen currently displayed and the area in the screen where the operation is detected among operations once determined that it is unnecessary to record them by the criteria shown in FIG. 4 is shown. More specifically, in the criteria shown in FIGS. 9A and 9B, it is defined whether or not it is necessary to record operations for each type of detected operations (here, only operations determined that it is unnecessary to record by the criteria shown in FIG. 4 are considered) regarding combinations of the screen currently displayed and the area in the screen where the operation is detected. In FIGS. 9A and 9B, YES indicates that it is necessary to record, and NO indicates that it is unnecessary to record. In FIGS. 9A and 9B, while “operation examples” are shown to indicate the operations that the application 213 executes if the corresponding operation is detected as reference, it is unnecessary to include this information in the actual criteria for determining whether or not it is necessary to record.

In some cases, since it is necessary to modify the criteria for determining whether or not it is necessary to record depending on the type of screen currently displayed, it is useful to enable this kind of configuration described above in order to make it easy to record operations suitable for reproducing.

In some cases, the screen is not partitioned into multiple areas. In this case, whether or not it is necessary to record can be determined for each combination of the screen and the operation type.

If there are only two screens, e.g., a screen that all types of operations are to be recorded such as a sequence recording screen for operation guidance and a screen that has no operation to be recorded such as one-shot input mode authentication screen (inputting user information), it is possible to determine whether or not the operations are to be recorded for each type of screen.

Instead of using the criteria in accordance with the operation target and/or the operation type shown in FIG. 4, it is possible to determine whether or not the operations are to be recorded by only using the criteria in accordance with the screen currently displayed, the area where the operation is detected, and/or the operation type.

In recording the operations, information for specifying the application that is active at that point, i.e., information that indicates which operation performed on which application is to be recorded can be stored associated with information on the series of operations. In reproducing the operations, it is possible to show a warning message if the application that corresponds to the operation to be reproduced is inactive, and it is possible to reproduce the operations upon launching the corresponding application if necessary and making the application active. This is because it is impossible to instruct the application to execute the intended recorded operations if the operations are reproduced assuming the application different from the recording mode is active.

The operations that the control unit 20 records are not limited to the operations accepted by the control panel 27. It is possible that operations accepted by other devices can also be similarly determined whether or not it is necessary to be recorded and recorded if they are determined to be recorded. Those “other devices” can be hardware keys included in the control unit 20 and control devices such as an external keyboard and a pointing device. In this case, the control unit 20 can be connected to the control devices arbitrarily, e.g., that can be wireless connection or wired connection. Otherwise, the control unit 20 can detect the operations accepted by the main unit 10 and record the operations.

The main unit 10 is not required to implement the functions of recording and reproducing the operations described in the embodiment above. The information processing system that records and reproduces the user operations can consist of the control unit 20 only.

While the image processing system 1 is comprised of the main unit 10 and the control unit 20 fixedly in the embodiment described above, the image processing system 1 is not limited to that example.

The control unit and the main unit (operating unit) can be completely separated hardware components. For example, the image processing system or the information processing system can be comprised of a mobile device such as a smart phone as the control unit and the image processing apparatus such as the MFP as the operating unit. Especially, in case the control unit is connected with the operating unit using wireless communication, these units can be configured as completely independent apparatuses.

In addition, it is unnecessary that the control unit corresponds to the operating unit on a one-on-one basis. For example, it is possible that the mobile device can operate the image processing apparatus that includes the control unit connected to the main unit by wired communication. Otherwise, multiple mobile devices can operate one image processing apparatus. Furthermore, one mobile device can operate multiple image processing apparatuses changing the operation target.

In addition, it is unnecessary to implement all functions of the control unit 20 and the main unit 10 in one apparatus. Multiple apparatuses can implement the functions of the control unit 20 and the main unit 10 by cooperating with each other. By contrast, it is possible to contain the control unit 20 and the main unit 10 in one case. Otherwise, when the control unit executes the application, it is possible to utilize multiple operating units simultaneously or selectively.

It is unnecessary that the operating unit includes the image processing engine such as the scanner or plotter. Any information processing apparatus can be used for that purpose so long as it operates based on a command received by the control unit. In addition, an apparatus that performs outputting physically other than processing information can also be used.

In the embodiment of the present invention, the program implements the functions of the information processing system described above by using one computer or cooperating multiple computers. Those effects described above can be realized by executing the program by the computer.

The program can be stored in a HDD, a ROM, or other nonvolatile storage media (flash memory or EEPROM etc.) included in the computer preliminarily. Also, it can be provided storing nonvolatile storage media such as CD-ROM, memory card, flexible disk, MO, CD-R, CD-RW, DVD+R, DVD+RW, DVD-R, DVD-RW, or DVD-RAM etc. Steps described above can be executed by installing the program stored in the storage media on the computer and executing it. Furthermore, it is possible to download the program from an external apparatus that includes the storage media that stores the program or stores the program in a storage unit, install the program in the computer, and execute it.

In addition, it is possible to download the program from an external apparatus that includes the storage device that stores the program or an external apparatus that stores the program in the storage unit, install the program in the computer, and execute the program by the computer.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

What is claimed is:

1. An information processing system, comprising:
an operation acceptance unit to accept operations;
a discrimination unit to distinguish between an operation to be recorded and an operation not to be recorded among the operations accepted by the operation acceptance unit; and
a recording unit to record the operations that the discrimination unit identifies as an operation to be recorded, in a memory, among the operations accepted by the operation acceptance unit.

2. The information processing system according to claim 1, wherein the discrimination unit determines whether or not the operation is to be recorded based on a type of operation accepted by the operation acceptance unit.

3. The information processing system according to claim 1, wherein the discrimination unit determines whether or not the operation is to be recorded based on a target of the operation accepted by the operation acceptance unit.

4. The information processing system according to claim 1, further comprising a display unit to display a screen,
wherein the operation acceptance unit accepts an operation on the screen displayed on the display unit and the discrimination unit determines whether or not the operation is to be recorded based on a type of screen displayed on the display unit.

5. The information processing system according to claim 4, wherein the discrimination unit determines whether or not the operation is to be recorded based on information on which area on the screen displayed on the display unit the operation accepted by the operation acceptance unit is performed.

6. The information processing system according to claim 1, further comprising:
a processing circuit to recognize an operation as a separator of a sequence among the operations accepted by the operation acceptance unit based on a predetermined criteria; and
a timer to count time elapsed from the operation that the processor recognizes as the separator of the sequence to an operation to be recorded in addition to the operations,
wherein the recording unit records the elapsed time.

7. The information processing system according to claim 6, further comprising a reproducer to reproduce the operations recorded by the recording unit,
wherein the reproducer reproduces a next operation after reproducing a given operation and an elapsed time if the elapsed time from the operation to the next operation is recorded.

8. An image processing method, comprising the steps of:
accepting operations;
distinguishing between operation to be recorded and operation not to be recorded among operations accepted by the step of accepting; and
recording the operations that the step of distinguishing identifies as an operation to be recorded among the accepted operations, in a memory.

9. A non-transitory, computer-readable recording medium storing a program that, when executed by an information processing system, causes the information processing system to implement a method of processing information,
the method comprising the steps of:
accepting operations;
distinguishing between operation to be recorded and operation not to be recorded among operations accepted by the step of accepting; and
recording the operations that the step of distinguishing identifies as an operation to be recorded among the accepted operations, in a memory.
